(19) United States
(12) Patent Application Publication
(10) Pub. No.: US 2026/0208009 A1
(43) Pub. Date: Jul. 23, 2026

(54) Golf Club Head and Method of Manufacturing Same

(71) Applicant: Eminent Spine LLC, Plano, TX (US)

(72) Inventor: Stephen Courtney, Plano, TX (US)

(21) Appl. No.: 19/455,708

(22) Filed: Jan. 21, 2026

Related U.S. Application Data
(60) Provisional application No. 63/747,862, filed on Jan. 21, 2025.

(51) Int. Cl. A63B 53/04; B33Y 80/00

(52) U.S. Cl. CPC A63B 53/0487; A63B 53/0445; A63B 2209/00; B33Y 80/00

(57) ABSTRACT

A golf club head is formed from substantially 100% titanium by an additive manufacturing process to include an osteo-porous surface. The osteo-porous surface, which approximates a scanned three-dimensional spongy bone structure, is integrally formed with the club head body so that it is non-inserted. Certain embodiments include a solid perimeter bounding a porous face, while other embodiments position the porous surface around a solid core. The porous region may be located on the crown, sole, rear, toe, heel, or hosel of the club head, providing opportunities for optimizing mass distribution, vibration damping, and performance characteristics. Methods of manufacturing include controlling the additive process to form the porous regions in selected areas while maintaining solid portions for structural integrity. The resulting golf club head may be attached to a putter, driver, wood, iron, hybrid, wedge, or other golf club configuration, thereby enhancing durability, feel, and performance.

### PRIORITY STATEMENT

This application claims the benefit of U.S. application Ser. No. 63/747,862, filed on Jan. 21, 2025 in the name of Stephen Courtney, and entitled “Golf Club Head and Method of Manufacturing Same”; the disclosure of which is hereby incorporated by reference, in entirety, for all purposes.

### TECHNICAL FIELD OF THE INVENTION

The present disclosure relates generally to golf equipment, and more particularly to the design and manufacture of golf club heads for improved performance characteristics.

### BACKGROUND OF THE INVENTION

Golf club heads have undergone significant design and material innovations in order to enhance player performance and experience. Traditional manufacturing methods and materials, such as casting and forging of various metals, have provided improved strength and durability; however, they can limit design freedom and the ability to precisely manipulate key performance variables, such as moment of inertia, center of gravity, and vibration control. Some manufacturers have attempted to reduce weight or reposition mass by using inserts, cavities, or composite structures, but these solutions may introduce complexities related to material bonding, part insertion, or assembly tolerances. As a result, there remains a need for golf club heads that incorporate advanced manufacturing features to achieve optimized weight distribution, enhanced feel, and improved structural integrity—all while simplifying or reducing the number of components required. Accordingly, there is an ongoing desire to identify and implement new processes and designs that can offer enhanced flexibility in shaping and material distribution for golf club heads, thereby providing opportunities for better performance, durability, and customization.

### SUMMARY OF THE INVENTION

It would be advantageous to develop a golf club head that significantly improves overall performance by precisely managing weight distribution, enhancing structural integrity, and optimizing feel. It would be desirable to enable a manufacturing approach that combines design flexibility with high durability, thereby promoting consistent ball striking and improved forgiveness. It would be further desirable to employ an advanced, streamlined process that simplifies production, eliminates unnecessary components or inserts, and provides consistent, repeatable results for golfers of varying skill levels.

Accordingly, in one aspect, the present disclosure provides a golf club head that is formed of substantially 100% titanium via an additive manufacturing process. During fabrication, at least one surface with an osteo-porous configuration is integrally formed as part of the club head body, approximating a scanned three-dimensional spongy bone geometry. This integration obviates the need for inserts or separate porous components. Certain embodiments incorporate a solid perimeter around a portion of the club head, while other embodiments use a solid core with the porous material extending around it to influence weight distribution, vibration damping, and overall performance.

In another aspect, methods of manufacturing such a golf club head are disclosed. These methods include forming a titanium body through additive manufacturing and simultaneously creating the porous surfaces in designated areas. In some embodiments, the porous regions are disposed on a face portion of the club head, whereas other embodiments place these regions on or around a core or along other portions, such as a crown or hosel. The resulting golf club head can be attached to various clubs—including putters, drivers, woods, irons, hybrids, and wedges—offering a range of performance characteristics tailored to different playing styles and preferences. By combining the flexibility of additive manufacturing with a unique porous structure, the present invention enables golf club heads with refined mass properties, improved structural integrity, and enhanced feel, all within a single, integrally formed design. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a top, front perspective view of an embodiment of a golf club head;

FIG. 2 is a front elevation view of the golf club head shown in FIG. 1;

FIG. 3 is a rear elevation view of the golf club head shown in FIG. 1;

FIG. 4 is a top plan view of the golf club head shown in FIG. 1;

FIG. 5 is a bottom plan view of the golf club head shown in FIG. 1;

FIG. 6 is a side elevation view of the golf club head shown in FIG. 1;

FIG. 7 is a side perspective view of the golf club head shown in FIG. 1;

FIG. 8 is a bottom rear perspective view of the golf club head shown in FIG. 1;

FIG. 9 is an enlarged or detailed view illustrating an osteo-porous surface formed on the golf club head;

FIG. 10 is a flowchart illustrating an example method of manufacturing the golf club head;

FIG. 11 is a top, front perspective view of an alternative embodiment of the golf club head; and

FIG. 12 is a rear elevation view of the alternative embodiment shown in FIG. 11.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

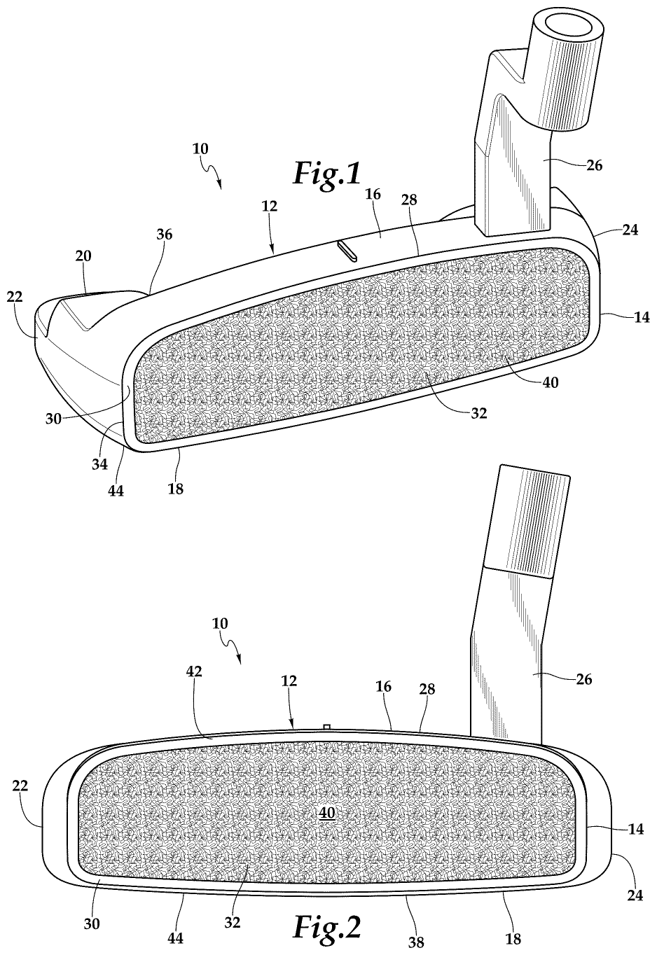

Referring initially to FIGS. 1 through 8, therein is depicted one embodiment of a golf club head, which is schematically illustrated and designated 10. More particularly, FIG. 1 is a top, front perspective view of an embodiment of the golf club head 10. In this illustrated embodiment, the club head 10 includes a body 12 having a face portion 14, a crown portion 16, a sole portion 18, a rear portion 20, a toe portion 22, and a heel portion 24. Extending upwardly from the heel portion 24 is a hosel 26, configured to receive or attach to a shaft (not shown). In some embodiments, the transition region between the face portion 14 and the crown portion 16 may define an edge 28 that extends from the toe portion 22 to the heel portion 24, while a perimeter region 30 bounding the face portion 14 is formed to be substantially solid. The illustrated view also shows an osteo-porous or bone-like lattice region 32 on selected areas of the body 12, for instance near the crown portion 16 or sole portion 18, which can be integrally formed by an additive manufacturing process. A solid core 34 may remain non-porous to provide structural rigidity. In this perspective, various angles and contours of the top side of the club head 10 can also be seen, such as the curved transition 36 between the crown portion 16 and the rear portion 20, or the shape of the toe portion 22 that merges seamlessly into the crown portion 16.

FIG. 2 is a front elevation view of the golf club head 10 shown in FIG. 1. From this vantage point, the face portion 14 is oriented toward the viewer, revealing the loft and bulge of the club head 10. The perimeter region 30 bounding the face portion 14 is visible along a top edge 28 (the crown-to-face transition) and along a bottom edge 38 that transitions between the face portion 14 and the sole portion 18. The toe portion 22 is located on the left side of the view, while the heel portion 24 is on the right side, adjacent to the hosel 26. The face portion 14 may include an osteo-porous or spongy lattice 32 in specific zones, or it may remain primarily solid with a localized porous area near a perimeter region to reduce weight. In some embodiments, the face portion 14 itself has an internal lattice structure 40 behind a thin, solid outer layer to optimize impact response. Also illustrated is the general curvature of the top line 42 (a contour that transitions into the crown portion 16) and the lower line 44 leading into the sole portion 18.

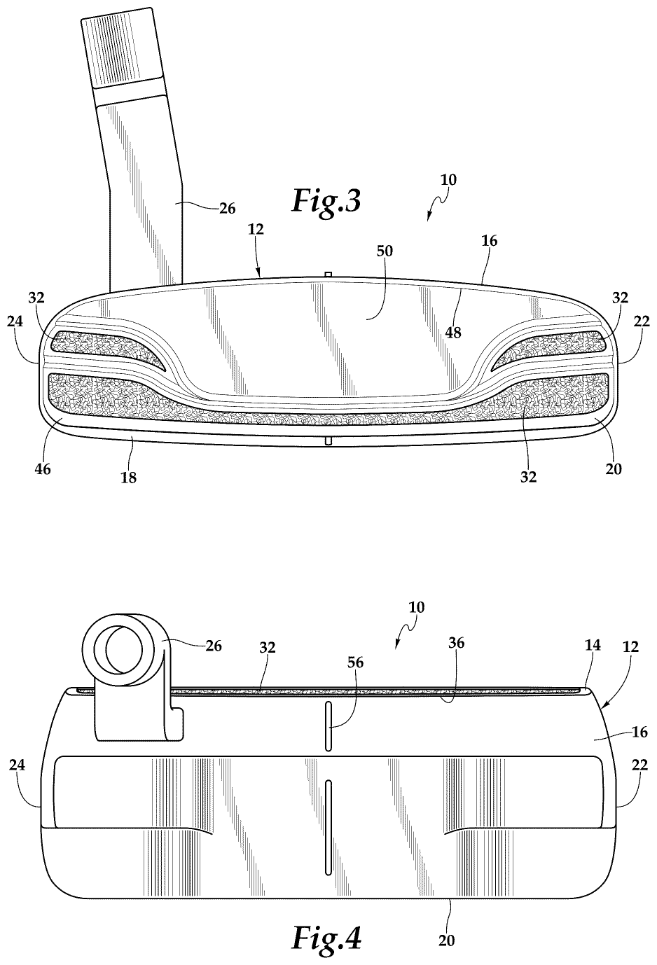

FIG. 3 is a rear elevation view of the golf club head 10 shown in FIG. 1, illustrating the rear portion 20 opposite the face portion 14. In this embodiment, the rear portion 20 can be contoured to manipulate the center of gravity. One or more sections of the rear portion 20 may also include an osteo-porous lattice 32 to reduce weight or modify vibration characteristics. A transition edge 46 delineates where the sole portion 18 merges with the rear portion 20, while another transition line 48 traces the boundary between the crown portion 16 and the rear portion 20. The toe portion 22 and heel portion 24 are visible on the lateral sides of the club head 10, highlighting how the body 12 wraps around from the face portion 14 all the way to the rear portion 20. The hosel 26 may also be partially visible, depending on the perspective, emerging from the heel portion 24. In some constructions, the rear portion 20 could house an internal cavity or reservoir 50 formed by additive manufacturing, permitting further manipulation of mass distribution within the club head 10.

FIG. 4 is a top plan view of the golf club head 10 shown in FIG. 1, illustrating the crown portion 16 as seen from above. This view demonstrates the overall footprint of the club head 10, from the toe portion 22 to the heel portion 24, and the transition 36 leading from the crown portion 16 down to the face portion 14. The hosel 26 is visible on the side, where it connects to the shaft (not shown). Depending on the design, an osteo-porous region 32 may be placed strategically along the crown portion 16 to lower or reposition mass for improved performance. For example, a porous zone near the rear portion 20 can help shift the center of gravity backwards, while a solid region near the face portion 14 maintains striking integrity. The top plan view also reveals any decorative or alignment features 56 that might be present on the crown portion 16, such as a line or marker to assist with ball alignment.

FIG. 5 is a bottom plan view of the golf club head 10 shown in FIG. 1, focusing on the sole portion 18. From this perspective, the bottom contour 58 of the sole portion 18 is evident, including any channels, rails, or grooves 60 that may be integrated for aerodynamic or turf-interaction benefits. A rear edge 62 marks the boundary between the sole portion 18 and the rear portion 20, while a front edge 64 transitions up to the face portion 14. As discussed above, the sole portion 18 can also include an osteo-porous surface region 32, or it can remain largely solid with just a partial porous strip near the perimeter region 30 to save weight. The toe portion 22 and heel portion 24 merge smoothly into the sole portion 18, defining the lateral extremities of the bottom surface. Depending on the embodiment, a removable or integrally formed weight port could be positioned on the sole portion 18 to alter the moment of inertia or to fine-tune the mass properties of the club head 10.

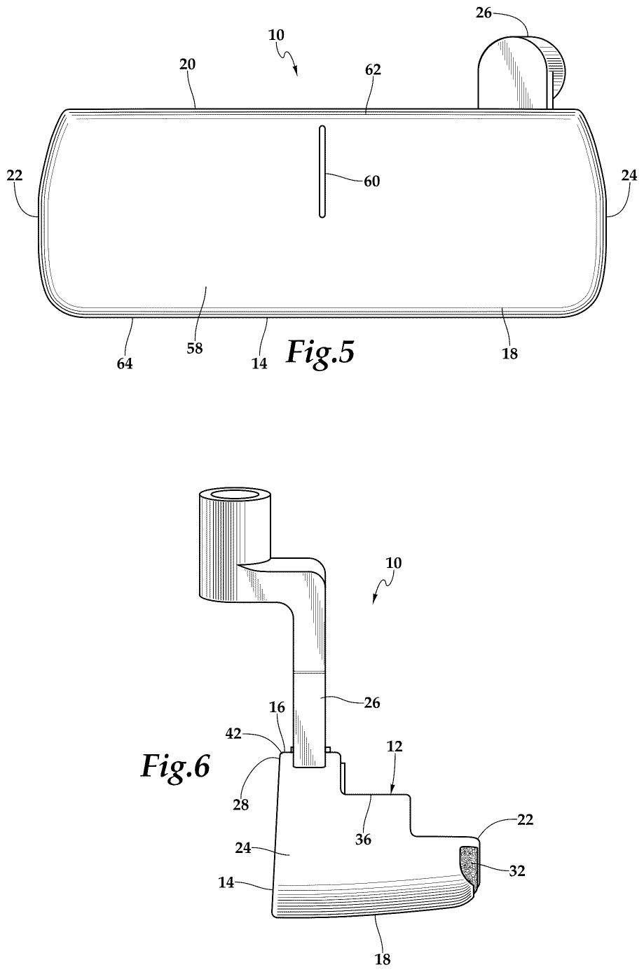

FIG. 6 is a side elevation view of the golf club head 10 shown in FIG. 1, corresponding roughly to the “heel-facing” side when in normal address position. Here, the heel portion 24 forms the boundary of the body 12. The face portion 14 is shown inclined at a loft angle, meeting the sole portion 18 along a leading edge 68. The crown portion 16 sweeps upward toward the top line 42, and an osteo-porous region 32 might be visible near or below the transition line 28 bounding the face portion 14. The depth and curvature of the crown portion 16 is evident from this vantage, as is any curvature or offset in the hosel 26, though the hosel 26 is mostly hidden on the opposite side. This side view underscores how thickness changes throughout the club head 10—particularly near the transition 36 from face portion 14 to crown portion 16 and from face portion 14 to sole portion 18.

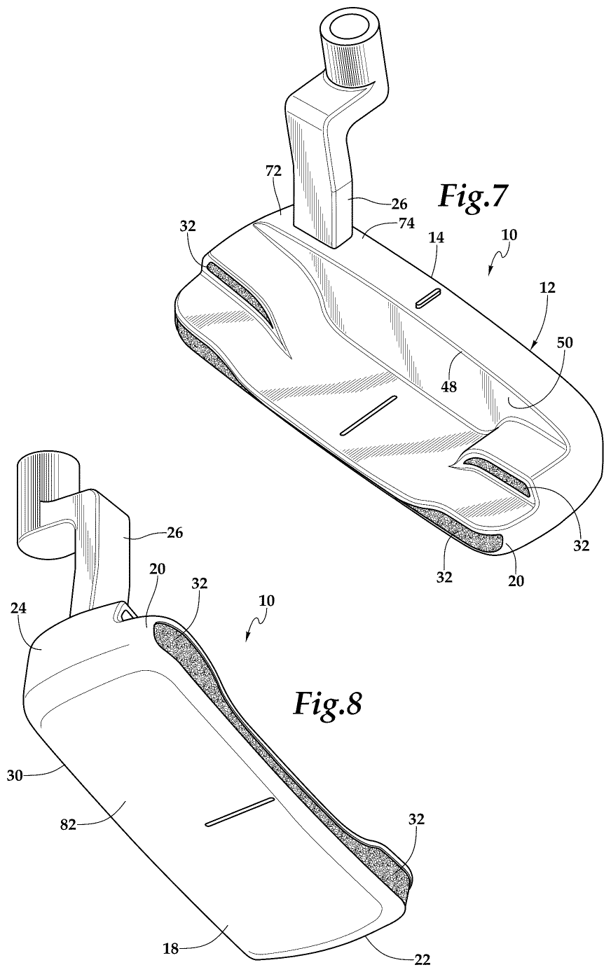

FIG. 7 is a side perspective elevation view of the golf club head 10 shown in FIG. 1, offering a more direct look at the heel portion 24 and the hosel 26. On this side, the hosel 26 may be integrally formed with the rest of the body 12 via an additive manufacturing process, ensuring a seamless transition 72 from the heel portion 24 to the hosel 26. If an osteo-porous lattice 32 is present on the heel portion 24, it could enhance vibration damping or reduce mass in this region. The face portion 14 forms a trailing edge 74 that merges into the heel portion 24 near the sole portion 18. The geometry of the rear portion 20 extends backward, as also partially seen in this elevation. In certain embodiments, a reinforced region near the hosel 26 can remain solid to handle stress concentrations when the club head 10 is attached to a shaft and used for repeated impacts.

FIG. 8 is a bottom rear perspective view of the golf club head 10 shown in FIG. 1. This angle reveals the underside contour of the sole portion 18 in conjunction with the rear portion 20, highlighting how they intersect along the rear edge 62. The crown portion 16 is partially visible, sloping downward to meet the rear portion 20 at the transition line 48. The toe portion 22 and heel portion 24 flank the sides of the body 12, with the heel portion 24 extending into the hosel 26. In some examples, the sole portion 18 includes a partially porous zone that is designed to enhance weight savings or a more solid region 82 (as shown) that helps maintain structural rigidity and energy transfer upon impact. A portion of the perimeter region 30 bounding the face portion 14 might be visible from this rear perspective, ensuring that the face portion 14 has a continuous, solid edge to maintain high-strength contact with the golf ball. The spongy lattice region 32 near the rear portion 20 could be further emphasized here, demonstrating a distinctive pattern or thickness that modifies the center of gravity and moment of inertia to improve ball launch and control.

Throughout these figures, the golf club head 10 is illustrated with various structural features that may be formed from substantially 100% titanium or another suitable material using an additive manufacturing process. Such a process can produce an osteo-porous or spongy bone-like lattice 32 integrally within certain areas of the club head 10, eliminating the need for separate inserts or bonded porous components. Some embodiments keep a solid core 34 inside the body 12 for strength, while selectively applying the porous structure 32 on exterior surfaces or near the perimeter region 30 to reduce mass and shift the club's center of gravity. The interplay between solid regions and porous regions can help tune the acoustic feedback, vibration damping, and overall feel at impact.

In addition, each figure demonstrates possible transitions between the face portion 14, crown portion 16, sole portion 18, and the rear portion 20, as well as the shape and position of the toe portion 22 and heel portion 24. This geometry influences performance characteristics such as launch angle, spin rate, and forgiveness. The hosel 26 may integrate seamlessly with the rest of the club head 10, or in alternate embodiments, it can be separately formed and attached. Although the figures show a single illustrative design, those skilled in the art will recognize that the shapes, angles, and porous distributions can vary according to manufacturing capabilities or performance goals. For example, one embodiment might include a large spongy lattice region 32 across the crown portion 16, while another might concentrate a lattice structure near the rear portion 20 for back-weighting. In some embodiments, the face portion 14 is primarily solid for durability, but includes discreet porous pockets or internal cavities behind the hitting surface. Likewise, the sole portion 18 might incorporate channels or indentations lined with the lattice to reduce aerodynamic drag or shift mass around the perimeter. Overall, FIGS. 1-8 illustrate the versatility of constructing a golf club head 10 with integrated porous or lattice structures 32, coupled with strategic placements of solid sections to maintain reliability under repeated impacts. By referencing these figures, one can appreciate how a balanced approach to geometry and material distribution can achieve improved forgiveness, tailored center-of-gravity positioning, and enhanced feel and sound upon ball impact.

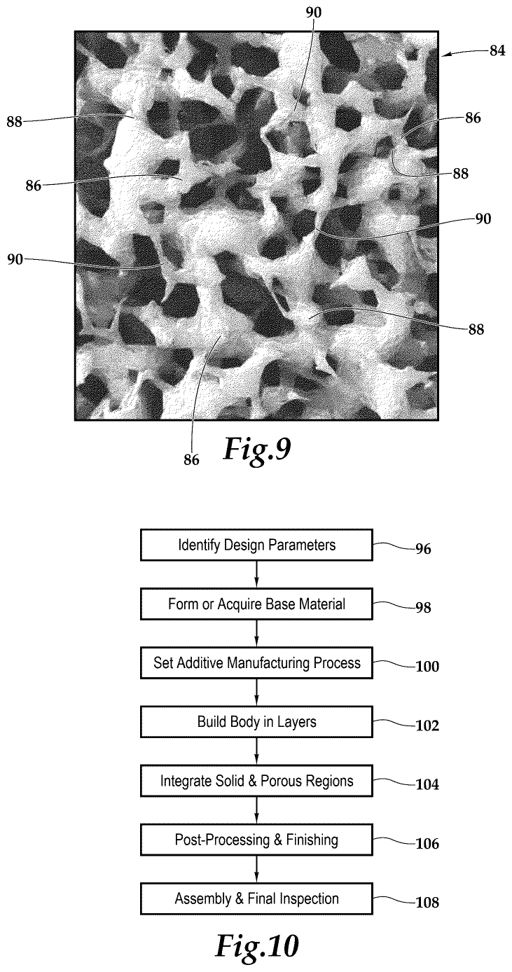

FIG. 9 is an enlarged or detailed view illustrating an osteo-porous surface 84 formed on the golf club head 10. In this magnified depiction, the lattice-like structure 84, which defines the integrated porous or lattice structures 32, appears as a network of interconnected nodes 86 and openings 88, together creating a three-dimensional, spongy bone-like texture. Each node 86 meets one or more struts 90 that traverse the surface to define the overall matrix, while the openings 88 provide weight-reducing cavities. In certain embodiments, the nodes 86 are uniformly distributed to ensure consistency in mass reduction and vibration management; in others, they may vary in density or thickness to fine-tune feel and forgiveness.

This detailed perspective also highlights how the osteo-porous surface 84 transitions seamlessly into surrounding solid regions of the club head 10. For example, various boundary lines may mark where the additive manufacturing process maintains a fully dense, non-porous layer for structural reinforcement. Such a transition can be engineered so that critical stress points—like areas near a face portion 14 or a hosel 26—remain robust, while peripheral areas are rendered in a porous configuration to offload unnecessary mass. In some constructions, the porous surface 84 extends only across the outermost layer of the crown portion 16 or sole portion 18, whereas in other versions, it penetrates deeper into the body 12 to create internal lattice cores or skeletal frameworks.

The material used to form the osteo-porous surface 84 may be substantially 100% titanium powder sintered or melted in situ, resulting in a non-inserted, integrally formed structure. By comparing FIG. 9 to the broader views in FIGS. 1-8, one can see how this microscopic lattice arrangement, magnified here for clarity, cooperates with the adjacent solid sections to shape both performance and aesthetics. Whether to reduce swing weight, optimize acoustics, or manipulate the club's center of gravity, this osteo-porous surface 84 embodies a precise manufacturing methodology aimed at maximizing the golf club head's 10 overall effectiveness.

FIG. 10 is a flowchart illustrating an example method of manufacturing the golf club head 10 according to one embodiment. This manufacturing approach leverages additive manufacturing techniques to form an osteo-porous surface while ensuring that critical areas remain sufficiently robust. The flowchart includes several blocks labeled with reference numerals continuing our prior numbering scheme, each block denoting a step in the process.

At Block 96 (Identify Design Parameters): In the first step, a user or engineering team determines the overall design requirements for the golf club head 10. These parameters can include target weight, center-of-gravity (CG) location, face thickness, loft, and the extent of any osteo-porous region 32. At this stage, performance goals—such as increasing forgiveness, manipulating acoustic feedback, or achieving a specific spin profile—are translated into digital specifications. Computer Aided Design (CAD) models can be generated or refined to include the crown portion 16, face portion 14, and sole portion 18 with the desired lattice-like surfaces. At Block 98 (Form or Acquire Base Material), next, the base material—often titanium alloy powders—must be prepared or sourced to meet the design criteria. Particle size distribution and material purity are confirmed to ensure consistent layer fusion. Additionally, a substrate or build plate may be selected and prepared, providing a stable platform for the additive manufacturing apparatus to deposit layers and build the body 12 integrally. At Block 100 (Set Additive Manufacturing Process), during this step, the user programs and configures the additive manufacturing machine. Here, layer thickness, laser or electron beam power, scanning speed, and atmosphere controls (e.g., inert gas) are set. The system's software is loaded with the digital rendering of the golf club head 10, which includes solid regions, the osteo-porous surface 84, and any internal lattice frameworks. Calibration ensures that the shape transitions—for example, between the crown portion 16 and the rear portion 20—are accurately reproduced.

At Block 102 (Build Body in Layers), with the machine configured, the process of layer-by-layer deposition begins. A thin layer of titanium powder is spread onto the build plate, and a high-powered energy source (laser or electron beam) selectively fuses particles according to cross-sectional slices of the CAD model. Successive layers are deposited and fused, gradually forming the club head's major features—such as the toe portion 22, heel portion 24, and face portion 14—as well as the integrated osteo-porous zones 84. Because these porous zones are non-inserted, they emerge seamlessly from the additive process rather than requiring mechanical attachment. At Block 104 (Integrate Solid & Porous Regions), during or after the layered build, the system ensures solid regions 92 (such as the perimeter region 30 bounding the face 14 or the hosel 26) maintain higher density, while designated surfaces adopt the lattice-like pattern. Each layer is subjected to precise energy input so that the transition from dense to porous is uniform, preventing stress risers or weak interfaces.

At Block 106 (Post-Processing & Finishing), once the build is complete, the club head 10 is removed from the build chamber. Excess powder is cleared away, and finishing steps—such as heat treatment, bead blasting, or minor machining—are performed. Heat treatment can enhance material properties, bead blasting can smooth or clean surfaces, and machining can refine edges or create features like a removable weight port 66 in the sole portion 18. The final result preserves the osteo-porous surface 84 in specified zones while ensuring key contact areas, like the face portion 14, remain robust. At Block 108 (Assembly & Final Inspection), in this concluding step, the golf club head 10 undergoes dimensional checks, CG verifications, and, if applicable, is attached to a selected shaft at the hosel 26. Quality control tests—like scanning electron microscopy of the porous lattice 88 or mechanical testing of the face portion 14—confirm conformance to design parameters. Once approved, the fully assembled club is ready for distribution or custom fitting.

By following the steps illustrated in FIG. 10, manufacturers can produce a golf club head 10 that integrates lightweight, bone-like lattice regions, offering refined mass distribution, acoustic properties, and enhanced playability. This methodology highlights how additive manufacturing can be adapted to create non-inserted, osteo-porous surfaces, seamlessly uniting solid and porous structures within a single, high-performance golf club head design.

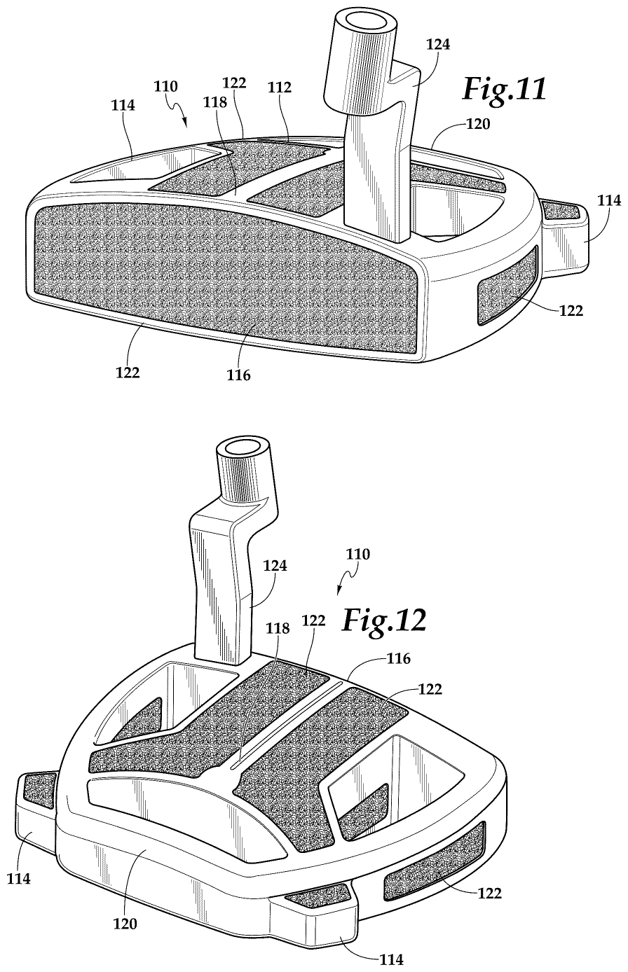

FIG. 11 is a top, front perspective view of an alternative embodiment of the golf club head 110, shown here in a shape reminiscent of a “mallet-style” putter. This mallet-style design includes a multi-component body 112 that extends rearward to form large, wing-like portions 114 on either side, dramatically increasing stability and moment of inertia (MOI). A putter face 116 sits at the front of the head 110, formed with or without an osteo-porous surface in selected regions to manage both weight and feel. The top alignment region 118 is situated near the front, offering visual guidance to aid in ball positioning, while a rear portion 120 bridges the wing-like sections 114 to create a pronounced cavity or channel beneath.

In some embodiments, the osteo-porous lattice portions 122 are strategically integrated into the body 112 via an additive manufacturing process, reducing unnecessary mass without undermining structural rigidity. By focusing lattice structures along the perimeter or within the wing-like sections 114, the putter's center of gravity can be shifted even farther rearward for improved forgiveness on off-center hits. A hosel 124 extends upwardly from one side, attaching the putter head 110 to a shaft (not shown). Like previous embodiments, solid zones or dense boundaries remain at high-stress interfaces—such as where the face 116 transitions to the body 112—ensuring impact durability.

FIG. 12 is a rear elevation view of the alternative embodiment shown in FIG. 11, highlighting the wide footprint and toe-to-heel expanse of the “mallet-style” X shape. From this angle, the putter face 116 and the alignment region 118 are most prominent, demonstrating how osteo-porous surfaces can seamlessly blend with traditional putting geometry to enhance performance through optimized mass distribution.

The order of execution or performance of the methods, manufacturing steps, and data flows illustrated and described herein is not essential, unless otherwise specified. In other words, elements of the methods and data flows may be performed in any order, unless otherwise specified, and the methods may include more or fewer elements than those disclosed herein. By way of example, it is contemplated that executing or performing a particular element before, contemporaneously with, or after another element are all possible sequences of execution, provided that the intended result of each method step remains achievable.

While this invention has been described with reference to illustrative embodiments, the description is not intended to be construed in a limiting sense. Various modifications, substitutions, omissions, and combinations of the illustrative embodiments—as well as other embodiments of the invention—will be apparent to those skilled in the art upon reference to the present disclosure. It is, therefore, intended that the appended claims encompass any such modifications, embodiments, and equivalents thereof that fall within the scope and spirit of the inventive concepts presented herein.

1-20. (canceled)

21. A golf club head comprising:
a body formed of substantially entirely of titanium by an additive manufacturing process;
a solid core disposed interiorly of the body;
at least one osteo-porous surface integrally formed as part of the body during the additive manufacturing process, the osteo-porous surface being non-inserted and formed to approximate a scanned three-dimensional spongy bone geometry;
the osteo-porous surface being disposed at least partially around the solid core;
a face of the golf club head including a porous region and a solid perimeter region bounding the porous region to form a continuous solid edge around the face; and
the osteo-porous surface comprising a lattice structure including a network of interconnected nodes and struts defining a plurality of openings, the nodes being joined by the struts to form a three-dimensional bone-like matrix, the openings providing weight-reducing cavities.

22. The golf club head of claim 21, wherein the osteo-porous surface is disposed on an exterior surface of the body.

23. The golf club head of claim 21, wherein the osteo-porous surface is disposed at least partially on a face portion of the golf club head.

24. The golf club head of claim 21, wherein the osteo-porous surface is disposed at least partially on at least one portion of the golf club head selected from the group consisting of a crown portion, a sole portion, a rear portion, a toe portion, a heel portion, and a hosel portion.

25. The golf club head of claim 21, wherein the solid perimeter region bounding the face is continuous around all sides of the face portion.

26. The golf club head of claim 21, wherein the osteo-porous surface is integrally formed during the additive manufacturing process without subsequent bonding or assembly.

27. The golf club head of claim 21, wherein the osteo-porous surface is configured to reduce mass relative to an equivalently shaped solid titanium body.

28. The golf club head of claim 21, wherein the golf club head is configured as a putter head.

29. The golf club head of claim 21, wherein the golf club head is configured as a golf club head selected from the group consisting of a driver, a fairway wood, an iron, a hybrid, and a wedge.

30. The golf club head of claim 21, wherein the solid core provides structural rigidity, and the osteo-porous surface attenuates impact-induced vibration and provides weight redistribution.
